(19) United States
(12) Patent Application Publication
(10) Pub. No.: US 2010/0091062 A1
(43) Pub. Date: Apr. 15, 2010

(54) IMAGE FORMING AND IMAGE CUTTING APPARATUS

(76) Inventors: Hideyuki Sakamaki, Chiba (JP); Tsunejiro Ioka, Chiba (JP)

Correspondence Address: Bruce L. Adams;Adams & Wilks, 17 Battery Place, Suite 1231, New York, NY, 10004, US

(21) Appl. No.: 12/449,634

(22) PCT Filed: Feb. 4, 2008
(86) PCT No.: PCT/JP2008/051788

§ 371 Date: Oct. 15, 2009

(30) Foreign Application Priority Data
Feb. 24, 2007 (JP) 2007-044781

(51) Int. Cl. B41J 29/38; B41J 2/01

(52) U.S. Cl. 347/16; 347/104

(57) ABSTRACT

Provided is an image forming and image cutting apparatus that may suppress vibrations occurring at a time of coupling an inkjet head and a cutting head, and does not require a large force at a time of separation, thereby making it possible to achieve downsizing of a drive motor for the inkjet head or the cutting head. In the image forming and image cutting apparatus, a first coupling member attached to the inkjet head and a second coupling member attached to the cutting head are coupled and separated by using a coupling pin which may be moved according to driving of a solenoid attached to the cutting head.

### TECHNICAL FIELD

The present invention relates to an inkjet head that prints an image on a recording medium, which is formed based on image data, and an image forming and image cutting apparatus that cuts the recording medium.

### BACKGROUND ART

In recent years, in order to achieve downsizing and cost saving for a printing apparatus such as an inkjet printer, there has been proposed an inkjet printer integrally including an inkjet head that prints an image formed based on image data on a recording medium and a cutting head including a cutter for cutting the image printed on the recording medium. For example, Patent Document 1 discloses an inkjet printer, which includes a mechanism for coupling and separating an inkjet head and a cutting head with and from each other by using magnets attached to the inkjet head and the cutting head, respectively.

Patent Document 1: JP 2006-35510 A

### DISCLOSURE OF THE INVENTION

### Problems to be Solved by the Invention

However, in the inkjet printer employing the conventional coupling technology, there may arise such problems as a trouble caused by unexpected vibrations occurring at the time of coupling due to a magnetic force, and an increase in size of a drive motor resulting from a necessity of a large force acting against the magnetic force at the time of separation.

The present invention has been made in view of the above-mentioned problems inherent in the related art, and an object of the present invention is to provide an image forming and image cutting apparatus that may suppress vibrations occurring at the time of coupling an inkjet head and a cutting head, and does not require a large force acting against a magnetic force at the time of separation, thereby making it possible to achieve downsizing of a drive motor for the inkjet head or the cutting head.

### Means for Solving the Problems

In order to achieve the above-mentioned object, according to a first aspect of the present invention, an image forming and image cutting apparatus that prints a desired image on a recording medium or cuts the recording medium based on image data includes coupling means for coupling and separating an inkjet head and a cutting head, the inkjet head moving along a guide rail disposed perpendicularly to a traveling direction of the recording medium and printing the desired image on the recording medium, the cutting head moving along the guide rail and including a cutter blade for cutting the recording medium, in which: the coupling means includes: a first coupling member attached to the inkjet head; a second coupling member attached to the cutting head; and a movable coupling pin; and the coupling means is configured to: when printing the desired image on the recording medium based on the image data: move the coupling pin; cause the coupling pin to penetrate the first coupling member and the second coupling member to thereby couple the first coupling member and the second coupling member with each other; and integrally move the inkjet head and the cutting head along the guide rail to thereby print the desired image on the recording medium based on the image data; and when cutting the recording medium: retract the coupling pin to cancel the coupling; separate the first coupling member and the second coupling member from each other; and move the cutting head alone along the guide rail, to thereby cut the recording medium.

According to a second aspect of the present invention, in the image forming and image cutting apparatus according to the first aspect of the present invention, the coupling pin has a shape corresponding to a shape of the first coupling member and a shape corresponding to a shape of the second coupling member.

According to a third aspect of the present invention, in the image forming and image forming and cutting apparatus according to the first aspect or the second aspect of the present invention, each of the first coupling member and the second coupling member has a hole processed so as to coincide with the coupling pin in shape.

According to a fourth aspect of the present invention, in the image forming and image cutting apparatus according to any one of the first to third aspects of the present invention, the first coupling member includes an elastic member, and is pressed and deflected by the coupling pin when the coupling pin is moved, to thereby be fitted with the coupling pin due to elasticity of the first coupling member.

According to a fifth aspect of the present invention, in the image forming and image cutting apparatus according to any one of the first to fourth aspects of the present invention further includes detection means for detecting positions of holes in the first coupling member and in the second coupling member, in which the detection means includes: a first detection means attached to the inkjet head; a second detection means attached to the cutting head; and a scale disposed along the guide rail.

According to a sixth aspect of the present invention, in the image forming and image cutting apparatus according to the sixth aspect of the present invention, the detection means detects the positions of the holes in the first coupling member and in the second coupling member by reading the scale using reading sensors attached to the first detection means and the second detection means, respectively.

According to a seventh aspect of the present invention, in the image forming and image cutting apparatus according to any one of the first to sixth aspects of the present invention, the coupling pin is moved in a predetermined direction by pin moving means.

According to an eighth aspect of the present invention, in the image forming and image cutting apparatus according to the seventh aspect of the present invention, the pin moving means includes a solenoid, and the solenoid is fixed to one of the inkjet head and the cutting head.

### EFFECT OF THE INVENTION

The image forming and image cutting apparatus according to the present invention provides such an excellent effect that vibrations occurring at the time of coupling the inkjet head and the cutting head are suppressed, to thereby achieve downsizing of the drive motor for the inkjet head or the cutting head.

### BRIEF DESCRIPTION OF THE DRAWINGS

FIG. 1 is a schematic view of an image forming and image cutting apparatus according to the present invention.

FIGS. 2A and 2B are views each illustrating a separated state of an inkjet head and a cutting head of the image forming and image cutting apparatus according to the present invention, in which FIG. 2A is a front view, and FIG. 2B is a top view.

FIGS. 3A, and 3B are views each illustrating a coupled state of the inkjet head and the cutting head of the image forming and image cutting apparatus according to the present invention, in which FIG. 3A is a front view, and FIG. 3B is a top view.

FIGS. 4A and 4B are views each illustrating an operation of a coupling pin of the image forming and image cutting apparatus according to the present invention, in which FIG. 4A is a view illustrating a state in the course of coupling, and FIG. 4B is a view illustrating a state after the coupling.

FIG. 5 is a configuration diagram of a position detection system for the inkjet head and the cutting head of the image forming and image cutting apparatus according to the present invention.

### DESCRIPTION OF REFERENCE SYMBOLS

3 inkjet head
4 cutting head
10 first coupling member
11 second coupling member
12 solenoid
13 coupling pin
14 first sensor
15 second sensor
16 scale

### BEST MODE FOR CARRYING OUT THE INVENTION

Hereinafter, a description is made of an image forming and image cutting apparatus according to an embodiment of the present invention with reference to the drawings.

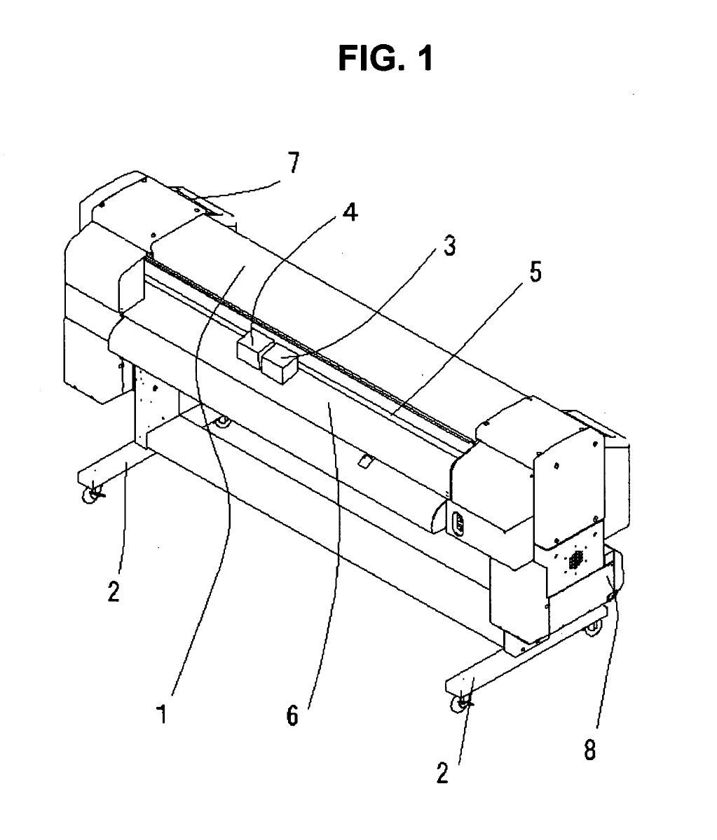

FIG. 1 is a schematic view of the image forming and image cutting apparatus according to the present invention. An image forming and image cutting apparatus 1 is an image forming and image cutting apparatus including an inkjet head 3 that discharges ink for printing, and a cutting head 4 including a cutter blade for cutting a recording medium. A stand 2 is a base that supports the image forming and image cutting apparatus 1. A guide rail 5 is a support member that enables reciprocal movement of the inkjet head 3 and the cutting head 4. A platen 6 is disposed under the inkjet head 3 and the cutting head 4, and supports a recording medium. An operation panel 7 includes a lamp for indicating a state of the apparatus and an input switch for setting various functions. An ink holder 8 is a holder to which an ink cartridge is fixed. A desired image is formed on a recording medium with the use of the inkjet head 3, based on an instruction contained in image data. Further, the recording medium may be cut with the use of the cutting head 4 including the cutter blade, based on an instruction contained in the image data.

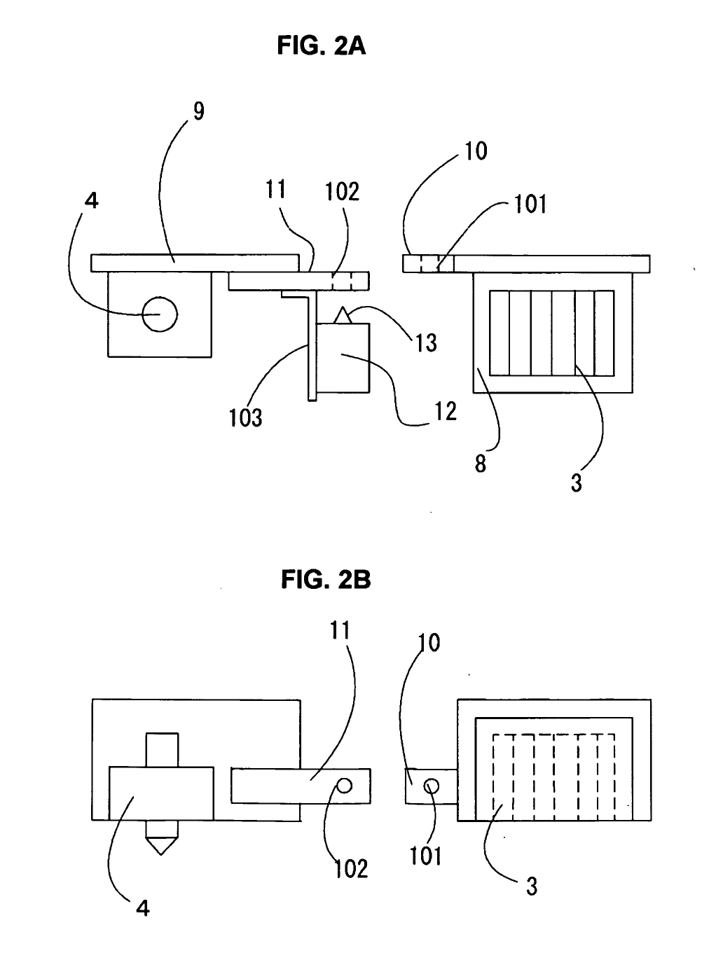

Next, an operation of coupling the inkjet head 3 and the cutting head 4 is described. FIGS. 2A and 2B are views each illustrating a separated state of the inkjet head 3 and the cutting head 4. FIG. 2A is a front view, and FIG. 2B is a top view.

An inkjet head carriage 8 fixes the inkjet head 3, and reciprocally moves along the guide rail 5 in the width direction of the recording medium. A cutting head carriage 9 fixes the cutting head, and reciprocally moves along the guide rail 5 in the width direction of the recording medium. A first coupling member 10 is attached to the inkjet head carriage 8. A second coupling member 11 is attached to the cutting head carriage 9. A solenoid 12 is attached to the cutting head carriage 9. A coupling pin 13, which may be moved by the solenoid 12, is provided to the solenoid 12. The coupling pin 13 fixes the first coupling member 10 and the second coupling member to thereby couple the inkjet head carriage 8 and the cutting head carriage 9 with each other.

The operation of coupling and separating the inkjet head 3 and the cutting head 4 of the image forming and image cutting apparatus according to the present invention is realized by aligning the second coupling member 11 attached to the cutting carriage 9 with the first coupling member 10 attached to the inkjet carriage 8, and driving the solenoid 12 attached to the cutting head carriage 9 to cause the coupling pin 13 to pass through the first coupling member 10 and the second coupling member 11. In forming an image, the solenoid 12 is driven to extrude the coupling pin 13, the coupling pin 13 passes through the first coupling member 10 and the second coupling member 11 to bring the first coupling member 10 and the second coupling member 11 coupled, and in the coupled state, the cutting head carriage 9 and the inkjet head carriage 8 are integrally driven. In cutting an image, the solenoid 12 is driven to retract the coupling pin 13, the first coupling member 10 and the second coupling member 11 are separated from each other, and the cutting head carriage 11 alone is driven while the inkjet head carriage 10 is placed at a maintenance station with the head capped.

The first coupling member 10 is a plate member of the inkjet head carriage 8, which protrudes toward the cutting head carriage 9 side. The first coupling member 10 is provided with a penetration side wall 101 forming a through hole into which the coupling pin 13 is inserted. The second coupling member 11 is a plate member of the cutting head carriage 9, which protrudes toward the inkjet head carriage 8 side. The second coupling member 11 is provided with a penetration side wall 102 forming a through hole into which the coupling pin 13 is inserted. The solenoid 12 is disposed to the cutting head carriage 9 so as to align the coupling pin 13 with a position at which the coupling pin 13 may pass through inside the penetration side wall 102. The solenoid 12 is fixed to a substantially L-shaped plate 103, thereby fixing the substantially L-shaped plate 103 to the second coupling member 11. With this configuration, alignment between the penetration side wall 102 of the second coupling member 11 and the coupling pin 13 is enabled on the second coupling member 11. The first coupling member 10 and the second coupling member 11 are arranged such that, when the cutting head carriage 9 is driven to approach the inkjet head carriage 8, the first coupling member 10 and the second coupling member 11 overlap each other in a moving direction of the coupling pin 13 without colliding with each other.

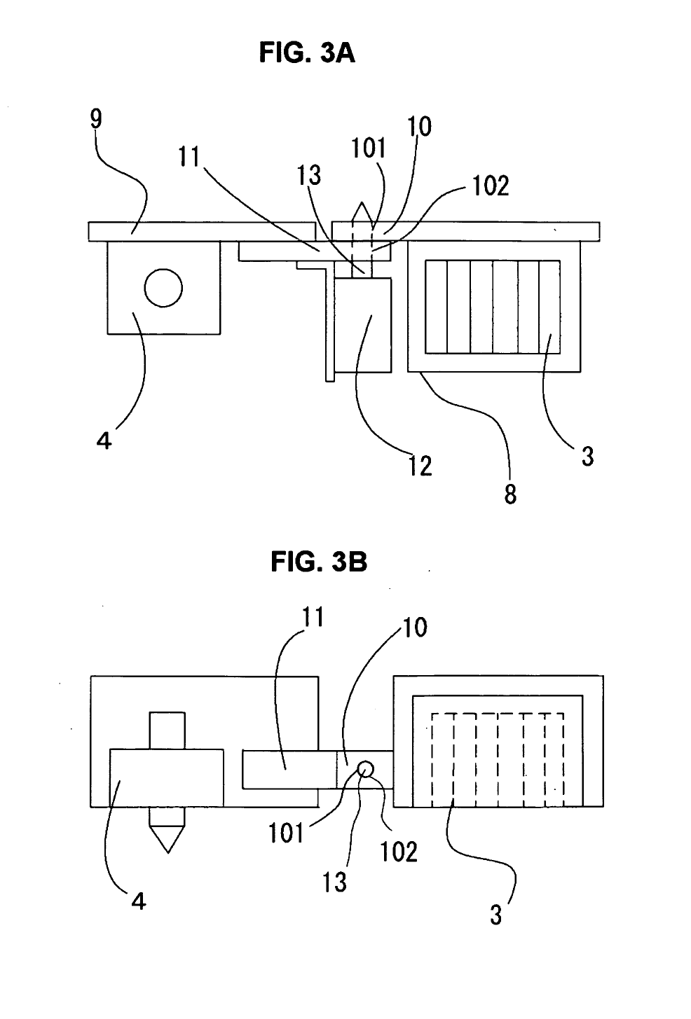

FIGS. 3A and 3B are views each illustrating a coupled state of the inkjet head 3 and the cutting head 4. FIG. 3A is a front view, and FIG. 3B is a top view. The solenoid 12 is driven to move the coupling pin 13. The coupling pin 13 passes through inside the penetration side wall 101 of the first coupling member 10 and the penetration side wall 102 of the second coupling member 11 to fix the first coupling member 10 and the second coupling member 11, thereby coupling the cutting head carriage 9 and the inkjet head carriage 8 with each other.

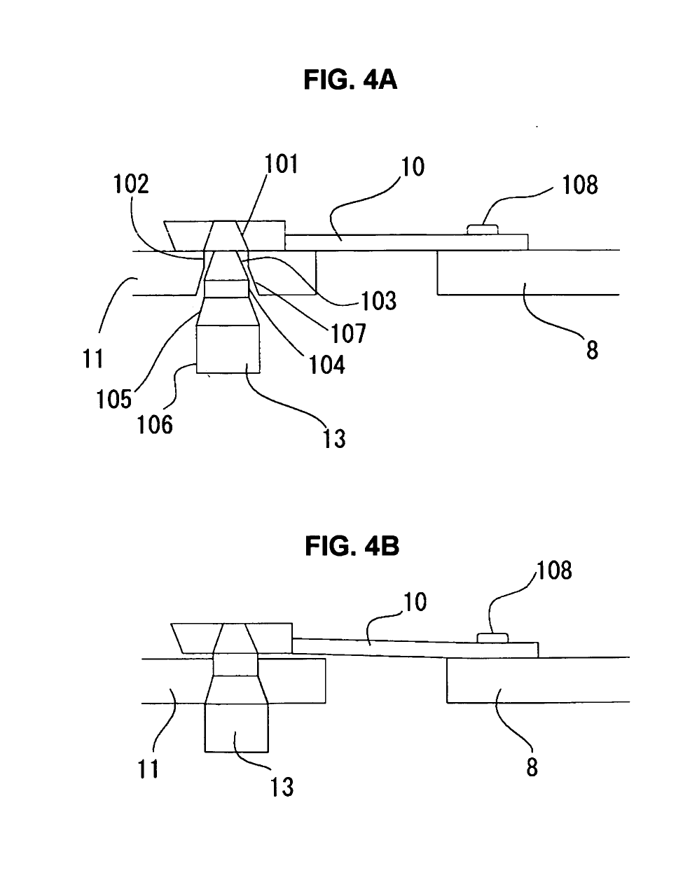

Next, a description is made of the first coupling member 10 attached to the inkjet head carriage 8, and the second coupling member 11 and coupling pin 13 attached to the cutting head carriage 9. FIG. 4 are views each illustrating an operation of the coupling pin. Each of the first coupling member 10 and the second coupling member 11 has a hole processed to have a shape identical with that of the coupling pin 13. The coupling pin 13 has a shape in which a stepped column is subjected to taper processing. The coupling pin 13 includes a first tapered portion 103, a first columnar portion 104, a second tapered portion 105, and a second columnar portion 106 in the stated order from the tip end of the coupling pin 13. The first penetration side wall 101 has a shape corresponding to the shape of the first tapered portion 103. The second penetration side wall 102 has its upper portion 106 in a shape corresponding to the shape of the first columnar portion 104, but the upper portion 106 is lower in height than the first columnar portion 104. The second penetration side wall 102 has its lower portion 107 in a shape corresponding to the shape of the second columnar portion 106. The cross sections of the first tapered portion 103 and the second tapered portion 105 decrease in area as approaching the tip end of the coupling pin 13. The first columnar portion 104 is smaller in diameter than the second columnar portion 106. The first coupling member 10 is an elastic member formed of a leaf spring. The first coupling member 10 is fixed at its base to the inkjet head carriage 8 by means of a fixing member 108. As illustrated in FIG. 4B, the coupling pin 13 is driven and pushed up by the solenoid 12, and when the second tapered portion 105 is fitted into the lower portion 107 of the second penetration side wall 102, the coupling pin 13 and the second coupling member 11 are fixed without any backlash. In addition, the first coupling member 10 is formed of the leaf spring, and hence, when the first coupling member 10 is pressed and deflected by the coupling pin 13, the first tapered portion 103 of the coupling pin 13 matches the first penetration side wall 101 of the coupling member 10 and is fitted thereinto. Accordingly, the coupling pin 13 and the first coupling member 10 are fixed without any backlash.

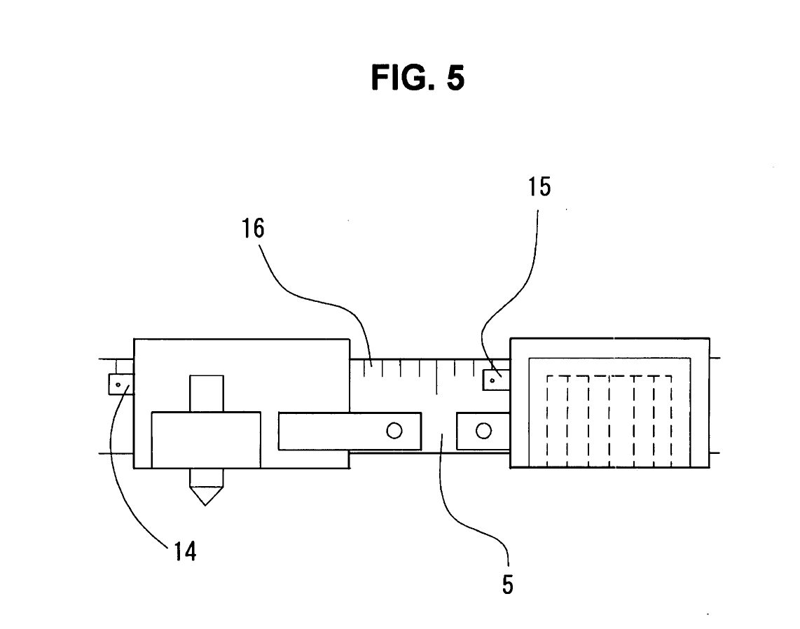

Next, a description is made of means for detecting positions of the first coupling member 10 and the second coupling member 11 attached to the inkjet head carriage 8 and the cutting head carriage 9, respectively. FIG. 5 is a configuration diagram of a position detection system for the inkjet head carriage 8 and the cutting head carriage 9. A first sensor 14 is a sensor attached to the cutting head carriage 9, and a second sensor 15 is a sensor attached to the inkjet head carriage 8. A scale 16 is a scale attached to the guide rail. The first coupling member 10 and the second coupling member 11 are attached at predetermined positions on the inkjet head carriage and the cutting head carriage, respectively. Reading and calculating values detected by the first sensor 14 and the second sensor 15 enables to determine where the inkjet head carriage 8 and the cutting head carriage 9 are located on the guide rail 5. The cutting head carriage 9 is driven according to the determined positions to align the first coupling member 10 and the second coupling member 11. It is desirable that the cutting head carriage 9 move to a position at which the coupling pin 13 may be inserted into the inside of the first penetration side wall 101 when the coupling pin 13 is moved, more desirably, a position at which outlines of the first penetration side wall 101 and the second penetration side wall 102 coincide with each other.

### INDUSTRIAL APPLICABILITY

The present invention is applicable to coupling between the inkjet head that prints an image formed based on image data on a recording medium and another device such as the cutting head that cuts the recording medium.

What is claimed is:

1. An image forming and image cutting apparatus that prints a desired image on a recording medium or cuts the recording medium based on image data, comprising coupling means for coupling and separating an inkjet head and a cutting head, the inkjet head moving along a guide rail disposed perpendicularly to a traveling direction of the recording medium and printing the desired image on the recording medium, the cutting head moving along the guide rail and including a cutter blade for cutting the recording medium, wherein:
the coupling means comprises:
a second coupling member attached to the inkjet head;
a first coupling member attached to the cutting head; and
a movable coupling pin; and
the coupling means is configured to:
when printing the desired image on the recording medium based on the image data:
move the coupling pin;
cause the coupling pin to penetrate the first coupling member and the second coupling member to thereby couple the first coupling member and the second coupling member with each other; and
integrally move the inkjet head and the cutting head along the guide rail to thereby print the desired image on the recording medium based on the image data; and
when cutting the recording medium:
retract the coupling pin to cancel the coupling;
separate the first coupling member and the second coupling member from each other; and
move the cutting head alone along the guide rail, to thereby cut the recording medium.

2. An image forming and image cutting apparatus according to claim 1, wherein the coupling pin has a shape corresponding to a shape of the first coupling member and a shape corresponding to a shape of the second coupling member.

3. An image forming and image forming and cutting apparatus according to claim 2, wherein each of the first coupling member and the second coupling member has a hole processed so as to coincide with the coupling pin in shape.

4. An image forming and image cutting apparatus according to claim 3, wherein the first coupling member comprises an elastic member, and is pressed and deflected by the coupling pin when the coupling pin is moved, to thereby be fitted with the coupling pin due to elasticity of the first coupling member.

5. An image forming and image cutting apparatus according to claim 1, further comprising detection means for detecting positions of holes in the first coupling member and in the second coupling member,
wherein the detection means comprises:
a first detection means attached to the inkjet head;
a second detection means attached to the cutting head; and
a scale disposed along the guide rail.

6. An image forming and image cutting apparatus according to claim 5, wherein the detection means detects the positions of the holes in the first coupling member and in the second coupling member by reading the scale using reading sensors attached to the first detection means and the second detection means, respectively.

7. An image forming and image cutting apparatus according to claim 4, wherein the coupling pin is moved in a predetermined direction by pin moving means.

8. An image forming and image cutting apparatus according to claim 7, wherein:
the pin moving means comprises a solenoid; and
the solenoid is fixed to one of the inkjet head and the cutting head.

9. An image forming and image cutting apparatus according to claim 7, further comprising detection means for detecting positions of the holes in the first coupling member and in the second coupling member,
wherein the detection means comprises:
a first detection means attached to the inkjet head;
a second detection means attached to the cutting head; and
a scale disposed along the guide rail.
